(19) United States
(12) Patent Application Publication
(10) Pub. No.: US 2024/0389630 A1
(43) Pub. Date: Nov. 28, 2024

(54) ADHD DIETARY SUPPLEMENT

(71) Applicants: Abeer Alghananeem, Louisville, KY (US); Roger Griggs, West Chester, OH (US)

(72) Inventors: Abeer Alghananeem, Louisville, KY (US); Roger Griggs, West Chester, OH (US)

(21) Appl. No.: 18/323,896

(22) Filed: May 25, 2023

(51) Int. Cl. A23L 33/15; A23L 29/00; A23L 33/00; A23L 33/105; A23L 33/115; A23L 33/28

(52) U.S. Cl. CPC A23L 33/15; A23L 29/015; A23L 33/105; A23L 33/115; A23L 33/28; A23L 33/40

(57) ABSTRACT

Oral dietary supplement compositions include predetermined ratios of two or more ingredients including preselected minerals, vitamins, fatty acids, and extract components, which, when ingested, are effective for management of one or more symptoms associated with attention deficit hyperactivity disorder (“ADHD”) and related disorders such as anxiety disorder and mood disorder (e.g., bipolar disorder).

### FIELD

In general, the present subject matter is directed to a composition for management of one or more symptoms associated with attention deficit hyperactivity disorder (“ADHD”). More particularly, the present subject matter is directed to a dietary supplement composition for managing ADHD and related disorders.

### BACKGROUND

Attention deficit hyperactivity disorder (“ADHD”) is a neurodevelopmental disorder characterized by excessive amounts of inattention, hyperactivity, and impulsivity that are pervasive, impairing in multiple contexts, and otherwise age-inappropriate. [Diagnostic and Statistical Manual of Mental Disorders (5^{th} ed.), Arlington: American Psychiatric Publishing, 2013, pp. 59-65; Diagnostic and Statistical Manual of Mental Disorders, Fifth Edition, Text Revision (DSM-5-TR), Washington, D.C., American Psychiatric Publishing, February 2022; “Attention deficit hyperactivity disorder”: International Classification of Diseases 11th Revision, Feb. 2022 [2019], Archived from original on 1 Aug. 2018, Retrieved 8 May 2022; Foreman DM (February 2006), “Attention deficit hyperactivity disorder: legal and ethical aspects”: Archives of Disease in Childhood, 91 (2): 192-194.] ADHD symptoms arise from executive dysfunction; moreover, emotional dysregulation is often considered a core symptom. [Retz W, Stieglitz RD, Corbisiero S, Retz-Junginger P, Rösler M (October 2012), “Emotional dysregulation in adult ADHD: What is the empirical evidence?”, Expert Review of Neurotherapeutics, 12 (10): 1241-1251; Faraone SV, Rostain AL, Blader J, Busch B, Childress AC, Connor DF, Newcorn JH (February 2019), “Practitioner Review: Emotional dysregulation in attention-deficit/hyperactivity disorder—implications for clinical recognition and intervention”, Journal of Child Psychology and Psychiatry, and Allied Disciplines, 60 (2): 133-150; Shaw P, Stringaris A, Nigg J, Leibenluft E (March 2014). “Emotion dysregulation in attention deficit hyperactivity disorder”, The American Journal of Psychiatry, 171 (3): 276-293.] In children, problems related to paying attention may result in poor school performance. ADHD is associated with other neurodevelopmental and mental disorders as well as certain non-psychiatric disorders, which can cause additional impairment, especially in current social interaction.

Although people with ADHD struggle to focus on tasks they are not particularly interested in completing, they are often able to maintain an unusually prolonged and intense level of attention for tasks they do find interesting or rewarding; this is known as “hyperfocus.” Genetic factors play an important role; ADHD tends to run in families and has a heritability rate of 74%. [Faraone SV, Larsson H (April 2019), “Genetics of attention deficit hyperactivity disorder”, Molecular Psychiatry, 24 (4): 562-575.] Toxins and infections during pregnancy as well as certain brain damage may be environmental risks.

Attention deficit hyperactivity disorder, a common childhood disorder, can continue through adolescence and adulthood. Symptoms include difficulty staying focused, paying attention, and controlling behavior, as well as hyperactivity. An estimated number of children in a range 3-17 years-of-age ever diagnosed with ADHD, according to National Centers for Disease Control and Prevention (“CDC”), the national public health agency of the US, based on 2016-2019 data from a parents survey, is 6 million (9.8% of age range). The data, parsed into subsets of age range, between 3-5 years-of-age is 265,000 (2% of age range), between 6-11 years-of-age is 2.4 million (10% of age range), and between 12-17 years-of-age is 3.3 million (13% of range).

ADHD treatment protocols include medication, other behavioral treatments, or a combination of treatment methods. Currently available treatments focus on reducing the symptoms of ADHD and improving functionality. Treatments include prescription drugs, various types of psychotherapy, education and/or training, or a combination of treatments. Recent reported increases in the number of ADHD cases and related disorders have been accompanied by a rise in the use of prescription medications which include stimulants (i.e., amphetamines, and methylphenidate) as well as non-stimulants (i.e., guanfacine, clonidine, and atomoxetine). ADHD medications could reduce hyperactivity and impulsivity and may improve a subject's physical coordination and ability to learn, work, and focus.

However, there is risk of abuse and addiction with use of stimulants. Thus, children taking stimulants must be monitored closely for commonly reported side-effects which include decreased appetite, anxiety, irritability, and sleep problems. Some children report other, less frequent side effects with stimulants, such as cardiovascular or psychiatric problems.

ADHD treatments in adults could be complex and require special considerations, due to potential drug-drug interactions. As with all prescriptions, individuals should disclose other medications they take when discussing potential ADHD medications with a health care provider. Medications for common adult comorbidities—e.g., high blood pressure, diabetes, depression, anxiety, chronic pain disorders or other issues—may interact with ADHD drugs.

Health care providers and parents agree that there is an unmet present need for safe, effective ADHD management and management of related disorders in advance of, or in conjunction with, prescribed ADHD medications, to alleviate the symptoms, reduce the dose requirements of stimulants, or provide ‘drug holidays’ when children are not in school, as well as to minimize side effects.

### SUMMARY

One of the challenges in managing ADHD and related disorders is a rush to prescribe medications (stimulants and non-stimulants) that may help in managing the disorder but may have potential side effects that may have a negative impact on quality of life, both for the care giver and for children. The present subject matter is directed to a unique dietary supplement composition which for some may alleviate the many symptoms common to ADHD and related disorders.

The present subject matter generally relates to dietary supplements and more particularly relates to a unique dietary supplement/nutraceutical formulation. As used throughout this patent specification, the term “neutraceutical” shall be understood to be a pharmaceutical alternative that claims certain physiological benefits. The term shall be understood to mean a food which contains health-giving additives, and which provides certain medical or physiological benefits. Dietary supplement/nutraceutical formulations of the present subject matter, when combined with diet and lifestyle modifications, are intended for use in “Advance” of any diagnoses, formal treatments, or medical interventions of behavioral problems in children having attention deficit hyperactivity disorder (ADHD), thereby promoting patients' wellbeing and reducing health risks associated with ADHD.

The present subject matter, accordingly, is generally directed to an assortment of oral dietary supplemental compositions. Assorted oral compositions comprise various predetermined ratios of two or more ingredients including preselected minerals, vitamins, fatty acids, and extract components, which, when ingested, are effective for management of one or more symptoms associated with attention deficit hyperactivity disorder (“ADHD”) and related disorders such as anxiety disorder and mood disorder (e.g., bipolar disorder).

In yet another aspect, this novel composition is a bio-optimized dietary supplement designed to address dietary deficiencies common to maturing children having behavioral problems. To optimize its impact, one needs to first reduce or eliminate foods that may “provoke” such behavioral issues. Foods consumption most linked with behavior problems include those laden with sugar, synthetic food coloring, and artificial flavors. Lack of certain nutrients may also initiate ADHD like symptoms in children. Significantly, appetite suppression, a common side effect with stimulants, for example, may also further reduce the intake of necessary nutrients for the child to retain good mental health. Collateral to dietary modifications are additional needs for adequate amounts of sleep and moderate exercise.

The dietary supplement composition of the present subject matter is prepared in a pharmaceutically acceptable dosage form, and it is taken in a twice daily dose based on body weight. The dietary supplement is principally intended for use in “Advance” of any diagnosis, formal treatment, or medical intervention to give a healthcare provider a product to try before prescribing medication and to assure the clinician that the child's ADHD like symptoms and behavior are not the result of related dietary issues or as an adjunct to supplement nutrient depletion.

Attention issues, especially those in conjunction with behavior, are frequently treated with medications which caregivers and many physicians consider “harsh” for treating children. Also, common stimulant drug concerns include over-prescribed, and/or inadequate diagnostic techniques, potential for abuse, few sequential or progressive treatment alternatives, inappropriate drug titration, inadequate follow up, and inadequate coordination between parents and healthcare providers, as well as adverse side effects (e.g., appetite suppression, weight loss, growth inhibition, sleeplessness, restlessness, irritability, etc.). Many parents would prefer to avoid or delay the use of such medications by first initiating other, safer options. Developing an accurate ADHD/behavioral diagnosis takes time and significant expertise. Even then, behavioral disorders can be impacted by extraneous factors like diet, sleep deprivation, and maturation. Giving stimulant medications to very young children is not well studied, and the long-term impact of such use is not well known. Furthermore, discussions with many parents and patients on the use of prescription medication on a long term has revealed that nearly all of them would have preferred to first try a non-prescription regimen of a targeted nutritional supplementation to determine if prescription medications could have been avoided or taken less frequently or potentially in lower doses.

### BRIEF DESCRIPTION OF THE FIGURES

FIG. 1 plots data from an “Addivance” study showing clinically significant symptoms (attention/hyperactivity, depression/anxiety, conduct/aggression) for eleven participants.

FIG. 2 is a plot that depicts behavioral assessment scores for children (“BASC”).

FIG. 3 presents another plot depicting behavioral assessment scores for children.

### DETAILED DESCRIPTION

Since deficiencies of essential nutrients have been linked to attention/behavioral disorders, replenishment of deficient nutrients with essential supporting nutrients has been found to help overcome select behavioral issues while increasing ability to focus on tasks.

Studies have shown a correlation between behavior issues in children and low blood serum levels of such fatty acids as eicosapentaenoic acid and docosahexaenoic acid as well as trace metals, including zinc, magnesium, and iron. Eicosapentaenoic acid (abbreviated “EPA,” occasionally referred to as icosapentaenoic acid) is an omega-3 fatty acid, with a 20-carbon chain and five cis double bonds. EPA is introduced into the human diet by eating such oily fish as cod, herring, mackerel, salmon, menhaden, and sardine, as well as an assortment of certain types of edible algae, and/or by taking supplemental forms of fish oil or algae oil. Docosahexaenoic acid (abbreviated “DHA”), an omega-3 fatty acid, is a primary structural component of the human brain, cerebral cortex, skin, and retina. It can be synthesized from alpha-linolenic acid or obtained directly from maternal milk (breast milk), fatty fish, fish oil, or algae oil. [Guesnet P, Alessandri JM (2011), “Docosahexaenoic acid (DHA) and the developing central nervous system (CNS): Implications for dietary recommendations”. Biochimie. 93 (1): 7-12.] When such nutrients are supplemented, blood levels increase, and behavioral issues and focus are improved.

Therefore, the incorporation of essential phospholipids and a variety of vitamins in a nutrient supplement, in predetermined effective dosages, is also expected to improve the pharmacokinetics and pharmacodynamics of the critical and often depleted nutrients. The present subject matter has thus identified the most frequently depleted nutrients to provide a dietary supplement having effective ratios of these nutrients in its formulations.

Accordingly, in preferred embodiments, the dietary supplement compositions of the present subject matter are not prescription drugs and are not intended as replacements for powerful stimulant medications. The present subject matter makes no claim to efficacy in the presence of a formal diagnosis for any disorder or illness. It is designed as a “first step” for patients who may benefit from it (for the caregiver who may suspect a subject may have nutritional deficiencies which may be addressed by the formulation). Several clinical trials measured mood and cognitive function after consumption. From that data, clinicians witnessed a 25% to 30% positive response rate. Surprisingly, the clinical trials revealed an unexpectedly rapid onset of action and a statistically significant difference (p<0.005) from baseline (before treatment) in supporting cognitive and mental health of children who are known to exhibit certain behavior problems. The positive effects of the oral dietary supplement of the present subject matter together with parental support of a healthier diet and lifestyle had a profound effect on many aspects of these children's lives, such as improved cognitive function, including mental focus and memory, and improved emotional scores including reduction in anger, sadness, stress, frustrations, worry, negativity, and fear, resulting in reduced behavioral problems including less hyperactivity and reduction in disruptive and aggressive behavior.

In preferred embodiments, the dietary supplement composition of the present subject matter has been found, after clinical trials, to be beneficial to patients evidencing suspected behavioral disorders including depression, anxiety, stress, pre-ADHD symptoms (i.e., behavior, cognition, concentration, and poor academic performance), and has been found beneficial to patients diagnosed with other behavior problems, where such patents are averse to taking prescription or stimulant medications, and in cases where a healthcare provider suspects that the patient does not have good dietary habits.

Accordingly, the dietary supplement composition of the present subject matter is intended, when taken orally, to offer the clinician a first step prior to making a formal diagnosis, or to later introduce prescription drugs, for select behavioral disorders in children.

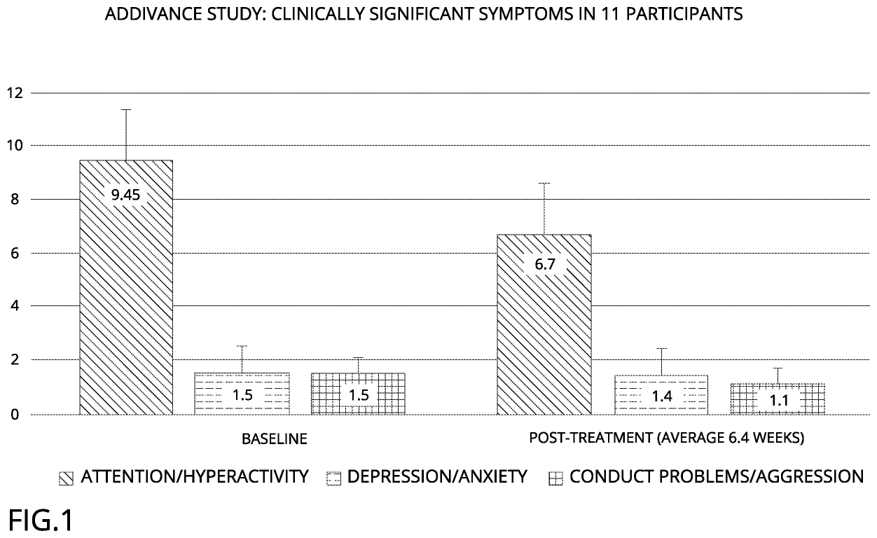

In embodiments, the present subject matter discloses synergistic and effective oral compositions comprising eleven ingredients (FIG. 1) in predetermined ratios useful in alleviating symptoms of ADHD. The nutrient curcuma longa, also called turmeric, is a flowering plant of the ginger family. Compositions contain predetermined concentrations of phosphatidylserine, vitamin C, magnesium, zinc, niacin, vitamin B6, folic acid, iron, vitamin D, certain fish oil powder as an EPA and DHA source, and curcuma longa extract.

The present subject matter also provides clinicians with methods for using effective amounts of the oral dietary supplemental compositions of the present subject matter to manage symptoms associated with ADHD or related disorders when select compositions of the present subject matter are administered, e.g., on a twice daily oral dose regimen.

The method comprises the consumption of the dietary supplement in conjunction with both diet and lifestyle modifications. In preferred embodiments, the consumption of the oral composition along with dietary and lifestyle modification may delay, reduce, or eliminate the need for harsh prescription drugs that would otherwise provide unintended and worrisome side effects. Implementation of an oral composition via a “pretreatment” protocol may help assure parents and clinicians that a child's behavior is not the result of related dietary deficiencies or other addressable lifestyle issues. Many parents and patients prefer to start with a non-prescription regimen or nutritional supplement to determine if prescription medications may be avoided or taken in lower doses.

In another aspect, the oral compositions are intended to supplement common nutritional deficiencies often noted in growing children and/or replenish those commonly depleted for patients already taking neurostimulator drugs. Correcting nutritional deficiencies and enhancing by adding assorted essential supporting nutrients may help ameliorate a broad spectrum of behavioral issues common with ADHD.

### EXAMPLES

Supplemental compositions of the present subject matter described hereinbelow provide exemplary oral compositions useful in management of ADHD, including related disorders.

Example 1: Ingredients in the supplemental compositions of this example comprise vitamin C, vitamin D, niacin, vitamin B6, folic acid, iron, magnesium, zinc, curcuma longa rhizome extract, phosphatidylserine, and fish oil powder as a source of EPA and/or DHA.

Example 2: Ingredients added, per serving, into the supplemental compositions are in the following proportions: from 5.6 mg to 9.4 mg vitamin C, from 75 International Units (IU) to 125IU vitamin D, from 2 mg to 3.4 mg niacin, from 0.3 mg to 0.4 mg of vitamin B6, from 50 mcg to 83.5 mcg of folic acid, from 1.6 mg to 1.9 mg of iron, from 29.7 mg to 36.3 mg of magnesium, from 2.3 mg to 2.8 mg of zinc, from 32. 3mcg to 34.3 mcg of curcuma longa rhizome extract, from 11 mg to 12 mg of phosphatidylserine, and from 107 mg to 113.7 mg of fish oil powder.

Example 3—Formulation Composition: In a preferred embodiment of the present subject matter, a composition formulated to alleviate symptoms of ADHD and/or related disorders comprises 7.5 mg vitamin C, 100 IU vitamin D, 2.7 mg niacin, 0.33 mg vitamin B6, 66.7 mcg folic acid, 1.77 mg iron, 33.3 mg magnesium, 2.5 mg of zinc, 33.3 mcg of curcuma longa rhizome extract, 11.25 mg of phosphatidylserine, and 110.4 mg of fish oil powder. Therefore, excluding excipients that may be present in the composition, the formulation may contain about 4% vitamin C, about 2% niacin, about 1% iron, about 20% magnesium, about 1% zinc, about 7% phosphatidylserine, and about 65% fish oil powder. Vitamin D, vitamin B6, folic acid, and curcuma longa rhizome extract may total to less than 1% of the non-excipient composition.

Example 4: Oral tablet dosing guidelines according to body weight at start of study. Supplemental composition tablets formulated according to Example 3 are to be dispensed every morning and afternoon as follows: for a child having a body weight of 11.3-22.2 kilograms (25-49 pounds), one tablet every morning and afternoon; for a child having a body weight of 22.7-33.6 kilograms (50-74 pounds), two tablets every morning and afternoon; for a child having a body weight of 34.0-44.9 kilograms (75-99 pounds), three tablets every morning and afternoon; for a child having a body weight of 45.4-56.2 kilograms (100-124 pounds), four tablets every morning and afternoon; for a child having a body weight of 56.7-67.6 kilograms (125-149 pounds), five tablets each morning and afternoon; and for a child having a body weight of weight of 68+kilograms (150+pounds), six tablets every morning and afternoon. While tablets are to be dispensed about the same time each day, afternoon tablets may be dispensed between noon and 3 pm, to accommodate a child's daily routine.

Example 5—Clinical evaluation of compositions of the present subject matter. An 8-week clinical trial was launched to evaluate supplementing the diet of eleven children (5-17 years-of-age) exhibiting behavior problems using dietary supplement formulations based on Example 3 and formulation variations to account for behavioral modifications. The clinical study design was one-arm to evaluate novel dietary supplement compositions with the following primary endpoints, to account for: (1) change from baseline in Behavior Assessment System for Children (BASC-3), for a 45-item Flex Monitor Assessment; and (2) change from baseline in parent and/or guardian and teacher observations and ratings.

Example 6 is directed to an oral dietary supplement composition comprising predetermined respective amounts of vitamin C, phosphatidylserine, magnesium (ion from magnesium bisglycinate), zinc, niacin, vitamin B6, folic acid, iron, vitamin D, curcuma longa rhizome extract, and fish oil powder (as a source of EPA and/or DHA), wherein the composition, when ingested, is effective for managing the symptoms of ADHD and related disorders.

Example 7 is directed to an oral dietary supplement composition comprising phosphatidylserine and fish oil powder. In the composition, the phosphatidylserine and fish oil powder are present in a ratio of 1:10 on a weight basis, with the result that the composition, when ingested, is effective to manage the symptoms of children with ADHD and related disorders.

Example 8 is directed to an oral dietary supplement composition comprising folic acid (in the form of folate compound) and curcuma longa rhizome extract wherein a ratio of the folic acid to the curcuma longa rhizome extract is 2:1 on a weight basis and wherein the composition, when ingested, is effective for managing ADHD and related disorders.

Example 9 is directed to an oral dietary supplement composition comprising curcuma longa rhizome extract, vitamin B6, and magnesium wherein a ratio of the curcuma longa rhizome extract to the vitamin B6 to the magnesium (ion from magnesium bisglycinate) in the composition is 1:10:1000, respectively, on a weight basis and wherein the composition, when ingested, is effective for managing ADHD and related disorders.

Example 10 is for an oral dietary supplement composition comprising vitamin D (cholecalciferol) and zinc, where a ratio of vitamin D to zinc is 1:1000 on a weight basis. The composition, when ingested, is effective for managing ADHD and related disorders.

Example 11 is directed to an oral dietary supplement composition according to Example 3. The composition, when ingested, is effective when used in connection with “a fast onset of action” (meaning, within 1-2 weeks) to alleviate one or more symptoms associated with attention deficit hyperactivity disorder (ADHD) and/or related disorders.

Example 12 is directed to an oral composition according to Example 6, wherein the composition, when ingested, is effective for use in “Advance” of a diagnosis, formal treatment, or medical intervention to restore a biological balance of a child with attention deficit hyperactivity disorder (ADHD) and/or related disorders. A secondary purpose of use in “Advance” is to assure a clinician associated with the child that behavior of the child is not a result of related dietary issues or an adjunct to supplement nutrient depletion.

Example 13 is directed to an effective amount of an oral composition, according to any one of Examples 6 through 12, which, when ingested, is to be used in “Advance” of any diagnosis, formal treatment, or medical intervention of predetermined behavioral problems in children related to attention deficit hyperactivity disorder (ADHD), for promoting well-being of the child, and preventing or reducing the health risks of ADHD.

Example 14 is for an oral dietary supplement composition for managing ADHD symptoms comprising ingesting an oral dosing regimen twice daily based on body weight.

Example 15 is directed to an oral dietary supplement composition comprising phosphatidylserine, vitamin C, magnesium, zinc, niacin, vitamin B6, folic acid, iron, vitamin D, curcuma longa extract, and fish oil powder (as a source of EPA and DHA), wherein relative effective amounts of the phosphatidylserine, the vitamin C, the magnesium, the zinc, the niacin, the vitamin B6, the folic acid, the iron, the vitamin D, the curcuma longa extract, and the fish oil powder in the composition, when ingested, are effective for improving the cognitive skills of a child with ADHD and/or related disorders.

Example 16 is directed to an oral dietary supplement composition according to any one of Examples 6 through 8, wherein the compositions (of this Example 16) are in pharmaceutically acceptable oral dosage forms including tablet, hard gelatin capsule, soft gelatin capsule, effervescent granule, gummy, gum, suspensions, and solutions, wherein such composition, when ingested, is effective for managing ADHD and related disorders.

Evaluation of data collected during this clinical trial provides encouraging evidence of a positive effect upon hyperactivity and attention, even though only eleven children participated in this study. In FIG. 1, the mean number of clinically significant symptoms for each category/symptom type (i.e., attention/hyperactivity; depression/anxiety; and conduct problems/aggression, for a baseline condition and for post-treatment conditions averaging 6.4 weeks) are presented. Error bars represent the standard error of the mean.

Example 17—Clinical evaluation of invention composition. Another eight-week clinical trial was executed to evaluate the effects of supplementing the diet of children with oral composition and then implementing suggested diet and lifestyle modifications. Example 20, described in detail below, relates to Examples 1-5, described in detail above.

The open-label study involved thirty-four children from across the United States. The age range was 5-17 years, with an even distribution across this range. Parents of these children answered a set of screening questions. If a predefined level of severity of behavioral issues was met, those parents were invited to sign certain informed-consent documents and, when signed, their child was enrolled in the study. Shortly thereafter, oral compositions and diet-lifestyle guidelines were mailed to each parent of a child enrolled in the study. At baseline (i.e., before a child began ingesting oral compositions or implementing any diet or lifestyle change), on a weekly basis for the following eight weeks, questionnaires were answered by the parent pertaining to behavior, using a personalized version of a Behavior Assessment System for Children (“BASC”), forty-five question form.

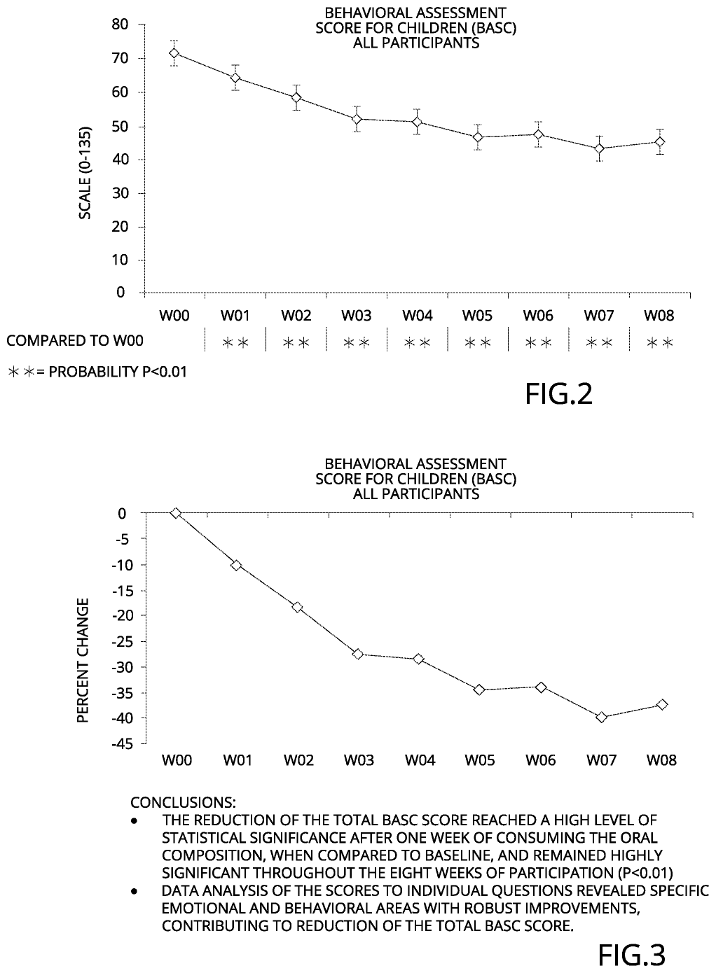

Data collected using this questionnaire-based tool on a weekly basis shows that an original total BASC score, based on forty-five questions and an average score of 72 at baseline (W00), was reduced in score after one week (W01), again reduced in score after two weeks (W02), also reduced in score after three weeks (W03), again reduced in score after four weeks (W04), again reduced in score after five weeks (W05), again reduced in score after six weeks (W06) also reduced in score after seven weeks (07), resulting in an average score of 45 after eight weeks (W08), a 37% improvement overall. Reduction of total BASC score had already reached a high level of statistical significance after one week of consuming the oral composition, compared to baseline, and remained highly significant (P<0.01) throughout eight weeks of participation in the study (FIG. 2). Percent change throughout eight weeks of participation in the study is plotted in FIG. 3.

FIGS. 2 and 3 present BASC score for all eleven participants of the study. FIG. 2 presents average scores±standard error of the mean values, where the level of statistical significance (P<0.10: (*), P<0.05: *, P<0.01: **) is shown compared to the baseline (W00); and where FIG. 3 presents the percent change from the baseline. Data analysis of the scores to individual questions revealed specific emotional and behavioral areas with robust improvements, contributing to a reduction of the total BASC score. The data is graphed in FIGS. 1, 2, and 3; and the study outcome is summarized as follows: (1) An interesting pattern was seen involving changes, over time, to this question: “Rushes through assigned work”. There was an initial rapid reduction in the average score over the first 2 weeks, followed by a plateau during weeks 3-5, and then another phase of improvement where the score was further reduced over the last 3 weeks of the study. The initial improvement plateaued at 24% reduction, and the second wave of improvement showed more than 40% improvement when compared to the baseline. (2) Average score for “Acts without thinking” showed a rapid reduction, reaching a high level of statistical significance at 2 weeks, and remaining highly significant for the remainder of the 8 weeks of participation. (3) Average score for “is easily frustrated” showed a rapid reduction after 2 weeks of ingesting the oral composition. The average score showed a 44% reduction after 5 weeks and remained at this reduced level for the remainder of the study. (4) The average score for “cries easily” showed a similar rapid reduction, reaching a statistical trend after 1 week of ingesting the oral composition. This question continued to show reduction throughout the study, reached a high level of statistical significance at 2 weeks, and remained there for the remainder of the 8 weeks. (5) The average score to “is overly aggressive” showed a gradual decline, reaching approximately 70% reduction during the final 3 weeks of the study. The improvement was statistically significant at 1 week and highly significant during the final 4 weeks of the study. (6) The average score for “has poor self-control” showed an almost 40% reduction after 2 weeks and stayed constant throughout the remainder of the study period. It is noteworthy that the improvement was rapid and reached a high level of statistical significance after 1 week of ingesting the oral composition and remained there throughout the 8 weeks. (7) The average score for “is able to concentrate for long periods” showed a gradual mild increase. (8) The average score for “worries” showed a 55% reduction after 5 weeks and remained close to that level for the remainder of the study period. The reduction reached a high level of statistical significance, at 1 week, and the improvement remained highly significant for the rest of the study. (9) The average score for “loses control when angry” showed gradual improvement, reaching a high level of statistical significance after 2 weeks of ingesting the oral composition and stayed at that score for the remainder of the study. (10) Average improvement reached approximately 50% reduction during the last 3 weeks of the study. (11) The reduction in the score for “has panic attacks” deserves special attention, since the actual scores were reduced to almost nil at the end of the study period. (12) Out of 34children entering the study, 11 children experienced panic attacks during the week prior to starting to ingest the oral dietary supplement composition, with 2 children experiencing panic attacks more than once during that week. However, during the last week of participating in the study, only 3 children had panic attacks. (13) Overall improvements during the study were gradual but the change was robust and plateaued during the final 4 weeks of the study with a 75% reduction, reaching statistical significance, at 8 weeks.

As a result, the positive effects of the oral composition and parent support of a healthier diet and lifestyle had a profound effect on many aspects of the children's lives participating in the study, including: (1) There was an improvement in cognitive function and coherent constructive behavior, including mental focus and memory. (2) There were broad improvements in emotional scores including reduction in anger, sadness, stress, frustrations, worry, negativity, and fear. (3) A different group of symptoms also collectively improved-these were behaviors typical of children with hyperactivity. The study was not specifically limited to hyperactive children, and not all study participants had hyperactivity.

However, the overall average scores for these behaviors were reduced over time and reached levels after 5-6 weeks where the improvements were statistically significant. These included behaviors such as restlessness, constant motion, making loud noises, talking over others, and acting out of control. The children were able to engage in more constructive social interaction, due to a reduction in disruptive and aggressive behaviors. In short, the ingestion of the oral dietary supplement composition of the present subject matter in conjunction with diet of participants and lifestyle changes worked in synergy, where adjustments in diet and lifestyle were likely made easier and more lasting through the daily consumption of the oral composition. The oral composition was safe and well tolerated in the patient population with no adverse events reported in the clinical study.

Formulations of the oral compositions of the present subject matter, along with the adoption of a healthier diet and lifestyle, have been proven to improve the mental focus, memory, and emotional scores, while reducing incidents of disruptive behavior and hyperactivity of individuals, particularly children, with ADHD and other related disorders.

The dietary supplement of the present subject matter is intended for use prior to diagnoses, formal treatments, or medical interventions, to assure clinicians that behavior observed is not the result of dietary deficiencies or as an adjunct to supplement nutrient depletion. Essential nutrients, which are frequently depleted by consuming a poor diet, or which may be due to the dietary impacts of common stimulant medications, have been linked to behavior problems, and supplementing with both deficient nutrients and other essential supporting nutrients may help overcome a broad spectrum of behavioral issues.

In embodiments, oral nutritional supplemental compositions of the present subject matter comprise a blend of up to eleven ingredients clinically proven to address symptoms related to behavioral issues including inability to pay attention to matters or to maintain focus when performing routine tasks as well as various problems associated with attention deficit hyperactivity disorder. The present subject matter, an over-the-counter product, provides the public with quick access and affordability, as needed, without prescription.

Conclusions: (1) The reduction of the total BASC score reached a high level of statistical significance after only one week of ingesting the oral dietary supplement compositions of the present subject matter, when compared to baseline, and remained highly significant (P<0.01) throughout the eight weeks of study participation. (2) Data analysis of the scores to individual questions revealed specific emotional and behavioral areas with robust improvements, which contributed to reduction of the total BASC score.

What has been described in detail throughout this patent specification are various embodiments of oral dietary supplemental compositions which, when ingested, are effective for managing ADHD and related disorders. While the present subject matter has been described with reference to exemplary embodiments, the present subject matter is not limited to these exemplary embodiments. On the contrary, many alternatives, changes, and/or modifications will become apparent to a person of ordinary skill in the art (“POSITA”) after this patent specification and its various examples are reviewed. Thus, all alternatives, changes, and/or modifications are to be treated as forming a part of the present subject matter insofar as they fall within the spirit and scope of claims that follow.

1. An oral composition comprising ingredients including vitamin B6, vitamin C, vitamin D, curcuma longa rhizome extract, fish oil powder, iron, phosphatidylserine, magnesium, niacin, folic acid, and zinc, wherein the ingredients in the oral composition, when ingested, are effective for managing attention deficit hyperactivity disorder (ADHD) and other disorders.

2. The oral composition of claim 1, wherein the fish oil powder is a source of EPA or DHA.

3. The oral composition of claim 1, wherein per serving the vitamin B6 is present in an amount of from 0.3-0.4 mg, the vitamin C is present in an amount of from 5.6-9.4 mg, the vitamin D is present in an amount of from 75-125 IU, the curcuma longa rhizome extract is present in an amount of from 32.3-34.3 mcg, the fish oil powder is present in an amount of from 107-113.7 mg, the iron is present in an amount of from 1.6-1.9 mg, the phosphatidylserine is present in an amount of from 11-12 mg, the magnesium is present in an amount of from 29.7-36.6 mg, the niacin is present in an amount of from 2-3.4 mg, the folic acid is present in an amount of from 50-83.5 mcg, and the zinc is present in an amount of from 2.3-2.8 mg.

4. The oral composition of claim 3, wherein per serving the vitamin B6 is present in an amount of 0.33 mg, the vitamin C is present in an amount of 7.5 mg, the vitamin D is present in an amount of 100 IU, the curcuma longa rhizome extract is present in an amount of 33.3 mcg, the fish oil powder is present in an amount of 110.4 mg, the iron is present in an amount of 1.77 mg, the phosphatidylserine is present in an amount of 11.25 mg, the magnesium is present in an amount of 33.3 mg, the niacin is present in an amount of 2.7 mg, the folic acid is present in an amount of 66.7 mcg, and the zinc is present in an amount of 2.5 mg.

5. The oral composition of claim 1, wherein the oral composition is formed into tablets, and wherein one tablet is dispensed every morning and afternoon to a child having a body weight of 11.3-22.2 kilograms, two tablets are dispensed every morning and afternoon to a child having a body weight of 22.7-33.6 kilograms, three tablets are dispensed every morning and afternoon to a child having a body weight of 34.0-44.9 kilograms, four tablets are dispensed every morning and afternoon to a child having a body weight of 45.4-56.2 kilograms, five tablets are dispensed every morning and afternoon to a child having a body weight of 56.7-67.6 kilograms, and six tablets are dispensed every morning and afternoon to a child having a body weight of or greater than 68 kilograms.

6. The oral composition of claim 1, wherein the phosphatidylserine and the fish oil powder are present in a phosphatidylserine to fish oil powder ratio of 1 to 10 on a weight basis, and wherein the oral composition, when ingested by a child, is effective for managing symptoms of the child associated with ADHD and other disorders.

7. The oral composition of claim 1, wherein the folic acid and the curcuma longa rhizome extract are present in a folic acid to curcuma longa rhizome extract ratio of 2 to 1 on a weight basis, and wherein the oral composition, when ingested, is effective for managing ADHD and related disorders.

8. The oral composition of claim 1, wherein the vitamin D and the zinc are present in a vitamin D to zinc ratio of 1 to 1000 on a weight basis, and wherein the oral composition, when ingested, is effective for managing ADHD and related disorders.

9. An oral dietary supplement composition comprising curcuma longa rhizome extract, vitamin B6, and magnesium, wherein a ratio of the curcuma longa rhizome extract to the vitamin B6 to the magnesium is 1 to 10 to 1000 on a weight basis, and wherein the oral dietary supplement composition, when ingested, is effective for managing ADHD and related disorders.
